(19) United States
(12) Patent Application Publication
(10) Pub. No.: US 2006/0121979 A1
(43) Pub. Date: Jun. 8, 2006

(54) Reconfigurable self-service wagering terminal

(75) Inventors: Thomas A. Kennard, Forest Hill, MD (US); John C. Corckran JR., Baltimore, MD (US)

Correspondence Address: Lipsitz & McAllister, LLC, 755 MAIN STREET, MONROE, CT, 06468, US

(73) Assignee: AmTote International, Inc., Hunt Valley, MD (US)

(21) Appl. No.: 11/003,633

(22) Filed: Dec. 2, 2004

(51) Int. Cl. G06F 17/00; G06F 19/00

(52) U.S. Cl. 463/25

(57) ABSTRACT

Apparatus and methods are provided for reconfiguring wagering terminals at a wagering facility. The terminals have a processor that provides a graphical user interface (GUI). A plurality of instruction sets are provided, different ones of said sets being executable by the terminal processor to implement different wagering terminal styles to a user via the GUI. Either a wagering facility operator or a terminal user can select from the plurality of instruction sets to provide a desired terminal style at the wagering terminal.

### BACKGROUND OF THE INVENTION

The present invention relates to terminals for use in wagering facilities, such as racetracks (e.g., horse or dog racing), jai alai frontons, or the like. In particular, the invention relates to self-service wagering terminals that are reconfigurable by the wagering facility or by the wagering patron (also referred to as the bettor, terminal user or customer) in order to provide different levels of service and/or a different look and feel to the terminal.

In accordance with the invention, configurations can be changed based on parameters such as the sophistication of the patron, demographics of the customers, day of the week, time of day, closeness of post time, how busy the wagering facility is, etc. Groups of terminals with different configurations can be provided in various locations throughout a wagering facility. Terminals can be reconfigured on a real-time basis as dictated by the needs of the wagering facility and/or the customer.

Race tracks and other locations where pari-mutuel wagering takes place commonly employ data processing equipment which automatically calculates and updates the odds for races based on the number and value of-the wagers placed on each entrant in the race or other sporting event. The betting information is fed to the data processor as the money is collected and the receipt for each bet is issued.

In teller assisted betting, the bettor, before each race, must be physically present at a central location at the track (or, off-track betting office) where the betting windows are located. The bettor selects the window which corresponds to the value of the bet he wishes to place. Behind the window is an agent who accepts the money and presses the appropriate buttons on a receipt (ticket) issuing machine, such that a receipt is issued with the wager information including, e.g., the horse, the type of bet (“Win”, “Place” or “Show”) and the value of the bet. This information is simultaneously transmitted to the data processor which uses the information to continuously update the odds. The bettor retains the receipt and, if the bet has been won, goes to a pay-out window where he submits the receipt to an agent who pays the bettor his winnings.

In order to overcome various drawbacks of such teller assisted betting, including the requirement for a large number of tellers (also referred to as ticket agents), the potential for human error, time consuming transactions and long lines at the teller windows, self-service terminals have been developed. Such terminals and the systems that they run on are described in the prior art, including L. J. Lange U.S. Pat. No. 4,322,612. However, even such self-service terminals have drawbacks. For example, the user interface, in attempting to provide a compromise between experienced patrons and novices, may frustrate experienced bettors by requiring extra steps for matters that seem obvious. Likewise, novice bettors may need even more assistance in placing bets than is provided by the terminal. Such user interfaces may reduce the number of bets placed, resulting in decreased revenue to the wagering facility, by consuming too much time for experienced bettors or frustrating novice bettors who end up canceling their transactions.

The current pattern in the pari-mutuel industry is for there to be a homogenous set of self-service user terminals at each betting location. This can be considered adequate if the customer base is fairly uniform and the terminal screens have become familiar enough to them. However, this also means that a more appropriate terminal mix will not be available at the wagering facility on different days with different mixes of customers.

Having a single terminal style per self-service machine has several disadvantages. For example, the user-interface is typically designed for regular visitors only, often to reduce keystrokes for those who already know how to enter a wager. Newer patrons require a learning period before being comfortable or appreciating the quick pace. Even regular patrons appreciate some variety, often just to see something new to prevent their place of leisure from seeming stale. Single style screens on existing terminals do not allow for easy changes. Moreover, new games or bet types introduced for the first time could lose some of their fresh appeal if shown among the “same old” screens. Still further, it is expensive and inefficient to swap out standard machines with different machines for special events for cross game attendees, slot machine, and/or card room players.

As visitor demographics changes, wagering facility operators either have to live with current screen styles, or negotiate with machine providers to make even the smallest of alterations. And, if the machine provider does make a change, it is difficult to match the variety of patron differences and preferences in time for a special event. Single style terminals simply do not provide the ‘tuning’ tools needed to keep pace.

It would be advantageous to provide a system where self-service wagering terminals can be reconfigured at any time to accommodate the needs of the wagering facility and or the terminal users. It would be further advantageous to enable operators of the wagering facility, terminal users, or both to reconfigure the wagering terminals. It would be still further advantageous to provide terminals that are capable of such reconfiguration via software or firmware, enabling the terminal configuration to be easily changed in the field without intervention by the terminal manufacturer.

The present invention provides wagering terminals and methods for reconfiguring such terminals which enjoy the aforementioned and other advantages.

### SUMMARY OF THE INVENTION

In accordance with the invention, a wagering terminal is provided which has a graphical user interface (GUI). A processor receives input from the GUI and displays information on a display associated with the GUI. Memory is provided to hold instructions which are processed by the processor to provide the display information and to respond to input from the GUI. The instructions are divided into a plurality of instruction sets, different ones of said sets being selectively executable by said processor to implement different wagering terminal styles to a user via said GUI.

The terminal styles can include, for example, a veteran wagering patron style (for an experienced bettor) and a novice wagering patron style (for an inexperienced bettor). wagering terminal in accordance with claim 1, wherein the terminal styles include a veteran wagering patron style and a novice wagering patron style. The terminal styles could also or alternatively include a fast throughput style adapted for use when a wagering facility at which the terminal is used to place bets is more busy, and a slower throughput style adapted for use when said wagering facility is less busy.

A terminal in accordance with the invention can be implemented such that particular instruction sets to be executed by the processor are selectable by a wagering facility operator. An implementation is also disclosed wherein the wagering facility operator selects a subset of the instruction sets to be available at the wagering terminal. The terminal user then selects one of the subset for execution by the processor to provide a desired wagering terminal style. Alternatively, the system can be implemented such that the customer (wagering terminal user) selects a particular instruction set from all of the sets available. The selected set is then used by the processor to provide the desired terminal style. In one embodiment, an identification element such as a user identification (ID) card, or a user's cash transaction card or token, is read by the terminal to automatically configure the terminal to a default style selected by the user. Information identifying the default style is stored on the user's identification element.

Methods are disclosed for reconfiguring wagering terminals at a wagering facility. The terminals have a graphical user interface (GUI), a processor for receiving input from the GUI and for displaying information on a display associated with the GUI, and memory for holding instructions to be processed by the processor for providing the display information and responding to input from the GUI. In accordance with one such method, a plurality of instruction sets is provided. Different ones of the instruction sets are executable by the processor to implement different wagering terminal styles to a user via the GUI. At least one of a wagering facility operator and a wagering facility patron is enabled to select from the plurality of instruction sets to provide a desired terminal style at the wagering terminal. A veteran wagering patron style can be provided to enable users to quickly enter bets with minimal terminal interaction. A novice wagering patron style can provide instructions and/or suggestions to users for placing bets.

The terminal styles associated with the methods of the invention can also, or alternatively, include a fast throughput style adapted for use when a wagering facility at which the terminal is used to place bets is more busy, and a slower throughput style adapted for use when said wagering facility is less busy. The fast throughput style can be the same as (or part of) the veteran wagering patron style, and the slower throughput style can be the same as (or part of) the novice wagering patron style.

In accordance with another aspect of the invention, the wagering facility operator can select a subset of the instruction sets to be available at the wagering terminal, and the wagering facility patron can select one of the subset of instruction sets for execution by the processor to provide a desired wagering terminal style. At least one particular instruction set to be executed by the processor can be automatically selected in response to a user identification element associated with a wagering patron. In implementing such a method, the wagering patron can be enabled to program the user identification element with a particular style that the patron desires to use at the wagering terminal.

Methods are also provided for configuring a plurality of self-service wagering terminals at a wagering facility. The terminals each have a graphical user interface (GUI), a processor adapted to receive input from the GUI and to display information on a display associated with the GUI, and memory for holding instructions to be processed by the processor for providing the display information and responding to input from the GUI. The instructions are divided into a plurality of instruction sets, different ones of the sets being selectively executable by the processor to implement different wagering terminal styles to a user via the GUI. A first set of the terminals is configured at the wagering facility with an instruction set implementing a first style to the first set of terminals. A second set of said terminals is configured at the wagering facility with an instruction set implementing a second style to the second set of terminals. The first and second styles can, for example, be based on demographics of patrons using the wagering facility. The configuring steps can be performed to create groups of terminals with different styles deployed at different locations in the wagering facility.

### BRIEF DESCRIPTION OF THE DRAWINGS

FIG. 1 is a block diagram of a self-service wagering terminal coupled to a central system;

FIG. 2 is a flow chart illustrating the configuration of the wagering terminal in accordance with the invention;

FIG. 3 shows an example “Amounts” terminal screen in a style directed to an experienced user;

FIG. 4 shows an example “Amounts” terminal screen in a style directed to a novice user;

FIG. 5 shows an example “Bet Types” terminal screen in a style directed to an experienced user;

FIG. 6 shows an example “Bet Types” terminal screen in a style directed to a novice user;

FIG. 7 shows an example “Races” terminal screen in a style directed to an experienced user;

FIG. 8 shows an example “Races” terminal screen in a style directed to a novice user;

FIG. 9 shows an example “Runners” terminal screen in a style directed to an experienced user;

FIG. 10 shows an example “Runners” terminal screen in a style directed to a novice user;

FIG. 11 shows an example “Tracks” terminal screen in a style directed to an experienced user; and

FIG. 12 shows an example “Tracks” terminal screen in a style directed to a novice user.

### DETAILED DESCRIPTION OF THE INVENTION

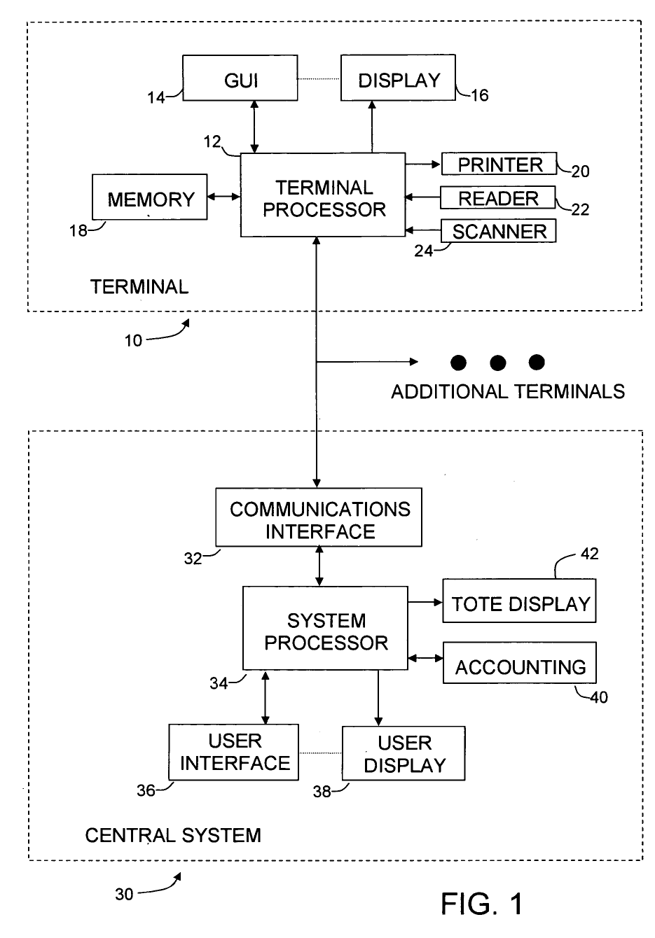

FIG. 1 illustrates a terminal 10 in accordance with the invention coupled to communicate with a central system 30. The central system is operated by the wagering facility (e.g., racetrack) and provides the wagering and business functions required by the facility. Included in these functions are the computation of pari-mutuel odds, handicapping, and payout on individual races or other activities on which bets are placed. In a racetrack environment, the central system also provides the data which is output to the public displays at the track, commonly referred to as “tote boards.” The central system is connected to the different components it services, including teller operated and self-service wagering terminals, by a computer communications network. Such networks are well known in the art.

The central system 30 includes a communications interface 32 for sending data over a network and receiving data from other components (e.g., wagering terminals) coupled to the network. A system processor 34 (e.g., computer processing unit—CPU) processes the data associated with the central system 30. Data to be output from the system processor to other components on the network is communicated via communications interface 32. Likewise, data received from the network is input to the system processor 34 via the communications interface 32.

Within the central system, a user interface 36 enables a human operator to input data to the system processor in a conventional manner. The user interface can comprise, for example, a keyboard, speech recognition system, touch screen and/or any other input device now known or developed in the future. A user display 38 provides graphic and textual output to the human operator as well known in the art. Where a touch screen interface is used, the user interface 36 and user display 38 are functionally related, as indicated by the dotted line between these components in FIG. 1. More particularly, the screen of the user display will operate as the touch screen input for the user.

System processor 34 also provides output for a conventional tote display 42 (showing, e.g., the odds of a particular race to the patrons at the racetrack). An accounting function 40 is also provided at the central system. This function provides the computation of odds, handicap, payout, etc. and also keeps track of all financial transactions and provides financial reports to the wagering facility operator. The various conventional functions of such a central system are well known in the art and further explanation is not necessary to enable one skilled in the art to implement such a system.

The present invention provides additional functionality to the central system as well as to the self service wagering terminals coupled thereto. In particular, apparatus and methods are provided for reconfiguring the style (e.g., look and feel, functionality, options available to users, interactivity, etc.) of the terminals. The reconfiguration can be initiated from the central system and/or at the terminals themselves.

The terminals 10 include a terminal processor 12, typically implemented by one or more microprocessors as well known in the art. Users (also referred to herein as “bettors” or “patrons” or “customers”) interface with the terminal processor via a graphical user interface (“GUI”) 14 which may be implemented as a touch screen on a display 16, as well known in the art. Memory 18 (e.g., random access memory (“RAM”), programmable read only memory (“PROM”), magnetic storage media such as a hard disk drive, or other forms of non-volatile memory or storage media) is provided for storing data used and produced by processor 12, as well as for storing the programs (software and/or firmware) that run on the processor 12. These programs are used to provide the GUI, data processing functions, ticket/voucher generation, customer identification, security functions, cash receipt and credit card processing, and other local functionality of the terminal 10. A printer 20 is provided in the terminal to print the wagering tickets, vouchers and/or receipts provided to the users. A reader 22 (e.g., a card, ticket, token or voucher reader) is provided to read tickets inserted for redemption or vouchers inserted for cash credit. Reader 22 can comprise, e.g., a mark-sense (e.g., barcode) receipt, betslip and player slip reader. Reader 22 could also be used to obtain data about the user (e.g., from a “User ID” card). Instead of using reader 22 to obtain the user data, an account card scanner 24 can be provided to scan a User ID. Such a scanner could comprise, for example, a magnetic reader device, a radio frequency (RF) device, or an optical mark reader (e.g., barcode reader). Swipe-style, dunk-style, or other capture technology styles could be used. Such printer, reader and scanning devices are well known in the art.

As illustrated in FIG. 1, the central system 30 can handle a large population of terminals (“additional terminals”) via the network. Thus, an entire wagering facility having hundreds of terminals can be run from the central system. A central system can also be provided to run multiple wagering facilities. Only one terminal 10 is shown in FIG. 1 for simplicity.

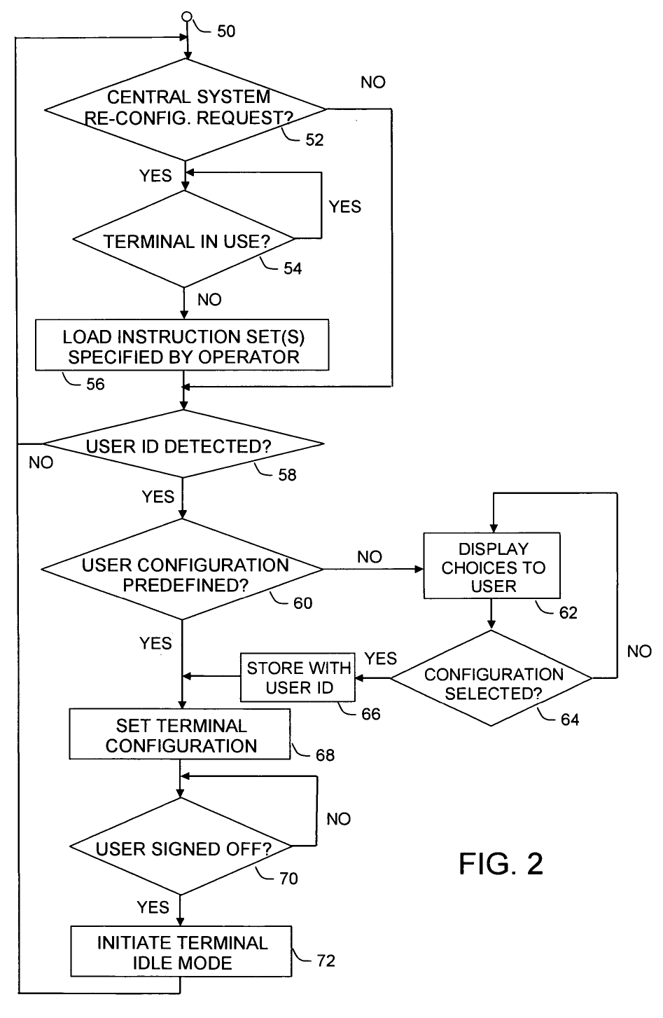

In accordance with the invention, the various terminals in a wagering facility, or in a plurality of wagering facilities, can be reconfigured from the central system or locally based on the needs of the facility or the individual user at any given time. An example routine for the reconfiguration of terminals is illustrated in the flowchart of FIG. 2. The routine is entered at node 50. At box 52, a determination is made as to whether a reconfiguration request has been made by the central system. If so, at box 54 a determination is made as to whether the terminal to be reconfigured is currently in use. If the terminal is in use, the routine waits until the terminal is not in use, so that a current user is not interrupted by the reconfiguration process.

If the terminal is not in use, the routine progresses to box 56, where one or more sets of computer program instructions are loaded into the memory 18 of the terminal by the central system. The specific instruction set(s) to be loaded are specified by the wagering facility operator via the central system user interface 36. Alternatively, the instructions could be loaded locally at the terminal by the wagering facility operator. However, such a scenario would require the operator to walk up to each individual terminal to be reconfigured, and load the desired instructions by, e.g., inserting a card or other device such as a memory stick into a terminal receptacle. Such local reconfiguration by the wagering facility operator is not the preferred implementation, as it is much more efficient to reconfigure individual terminals or groups of terminals from the central system via the communications network to which the terminals are already connected. Each instruction set will dictate a different style (e.g., look, feel and functionality) that will be presented by the terminal to the user when that instruction set is run.

In the event the wagering facility operator has not initiated a reconfiguration request via the central system, as determined at box 52, the routine will pass to box 58. At this step, the routine determines if another user has stepped up to the machine by detecting the user ID. The user ID can be, e.g., entered by the user via the terminal GUI 14. Alternatively, the terminal can be implemented to detect the insertion of a user ID card or other token into a terminal receptacle, such as a card reader 22 or scanner 24 of terminal 10. Upon detecting a user ID, the routine determines, at box 60, if a terminal configuration has been predefined for that user. For example, the user ID can inform the terminal as to whether the user has been designated as an experienced bettor or a novice bettor. If such a designation is associated with the user ID, the terminal will be configured accordingly, as indicated at box 68 of the routine. Thus, a terminal can be configured to behave in an advanced (e.g., faster and more efficient) mode for the experienced bettor, or in a more user friendly but less efficient (e.g., with step-by-step instructions) for a beginner.

In the event that no user configuration is predefined for a user who has entered a user ID (as in the case of a first-time user), the routine proceeds to box 62 where terminal configuration choices are presented on the terminal display 18. The user can then select a desired configuration (e.g., advanced, novice, graphic oriented interface, text oriented interface, with or without real-time help, with or without special offers, etc.). The routine will wait until a desired configuration is selected, as indicated at box 64. Once the user has selected the desired terminal configuration, this information will be stored in association with the user ID card (or other token) as indicated at box 66. Preferably, for security purposes, no dynamic information is stored directly on the user ID card, since the card may be lost or stolen. In such an implementation, user style preferences will be stored at the central system within account records associated with the user ID. After the selected terminal configuration has been stored, the terminal will be configured to the desired configuration as indicated at box 68. Provision can also be made for a user to change the predetermined configuration associated with his user ID. For example, the terminal GUI could include a button for modifying the user's preferred terminal configuration at any time. This feature is particularly useful to a user that graduates from novice to advanced status.

The terminal will then be available for use by the user to place bets and to take advantage of any other functionality provided. The routine, at box 70, monitors the user interaction to determine when the user is finished with and signs off of the terminal (e.g., by removing the user ID card, pressing a “finish” button on the GUI, or automatically after a period of no user activity). At this time, the terminal is placed into an idle mode, as indicated at box 72, where it awaits the next customer session.

By implementing the invention as described herein, each terminal can be set to a separate individual style or a uniform style when grouping units by area for event purposes. The style can be changed at any time, e.g., by local machine settings using a password and pressing a menu button, or automatically triggered by the central system using a limitless variety of criteria selected by the wagering facility management. It will even be possible for styles to be selected by account holders, and automatically change for them when they use their player account card (user ID) to log on.

One set of standard screens includes a popular style which has a reduced set of information shown on the terminal display. This lean style is preferable among bettors that are interested in a simplified user interface, for the sake of getting a wager into the system only moments before post time. Another terminal style can be provided which includes a richer theme. For horse racetracks, such a theme might include track logos, race purse and distance, jockey and trainer information, runner names and other interesting statistics such as preferred picks. This style is much more informative for patrons who have time to spend shopping for a good wagering opportunity.

Another terminal style is to provide a screen menu system, which walks a patron through each decision step of a wager with informative explanations. Track operators can also be provided with the ability to create new and unique styles themselves, via template software provided at the central system.

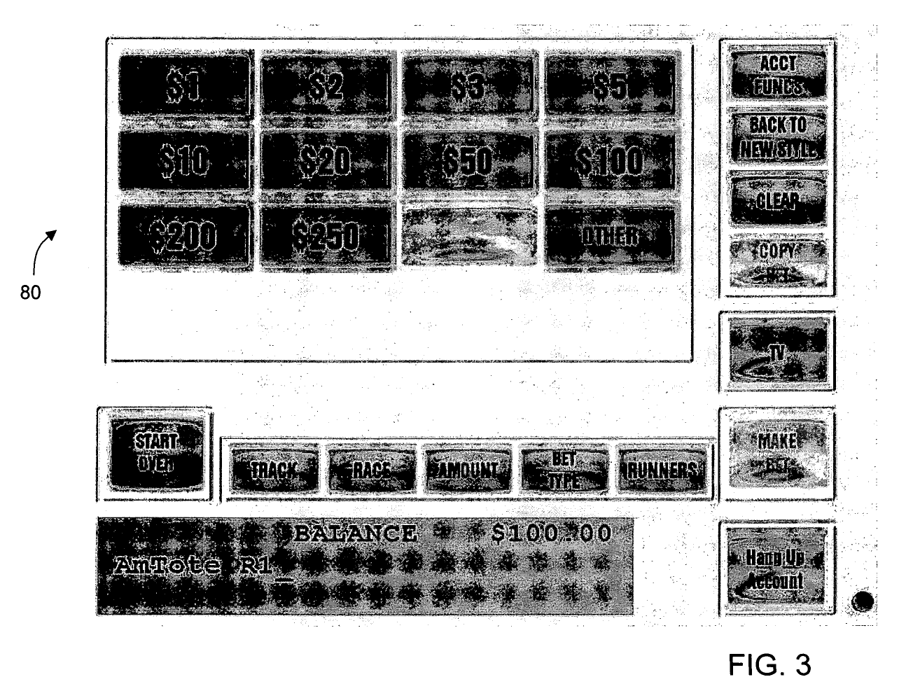

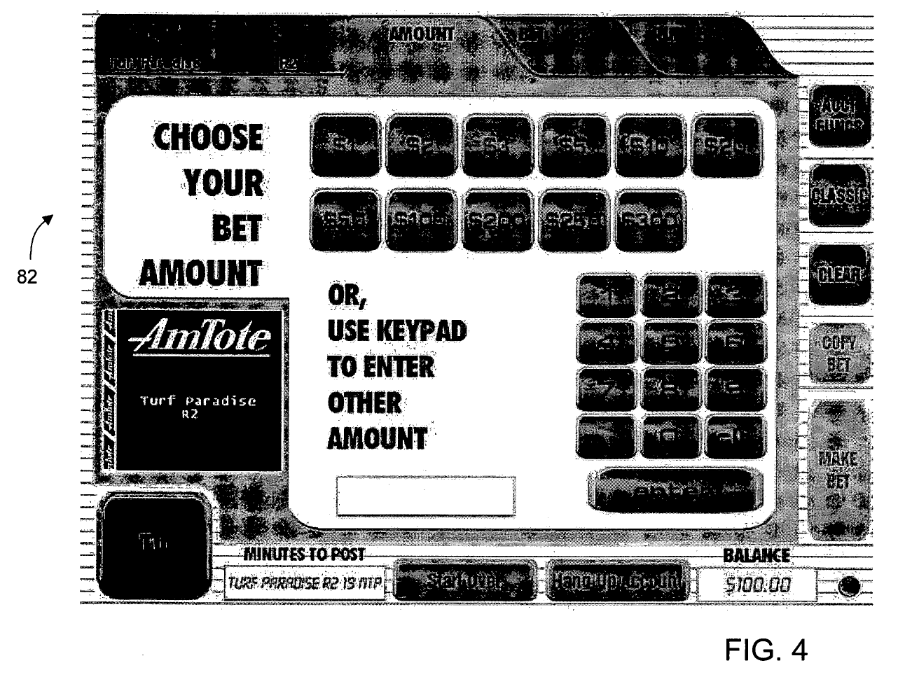

Examples of terminal styles are illustrated in the screens of FIGS. 3 to 12. FIG. 3 shows a screen 80 designed for an experienced bettor, for the selection of an amount to wager. A more graphics and feature rich screen is provided for novice bettors, as illustrated by screen 82 in FIG. 4. As can be seen, the novice style screen in FIG. 4 has a more attractive look, and can be implemented to provide instructions to the user as to how to select the amount of a wager. Selecting an amount through the novice style may, however, be less efficient in terms of processing time required.

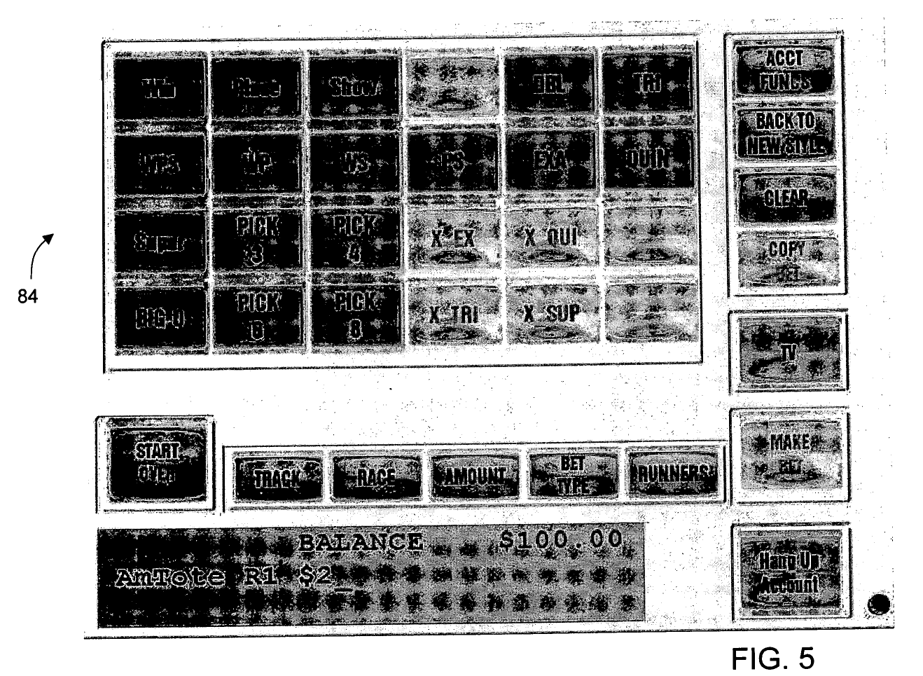

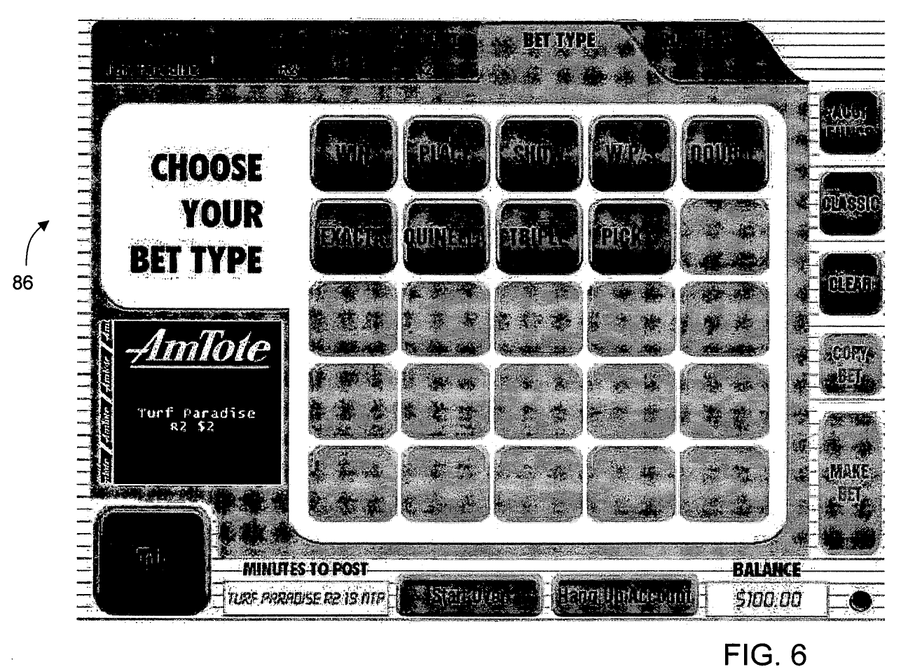

FIGS. 5 and 6 illustrate styles for selecting bet types and are oriented to an experienced and novice bettor, respectively. As can be seen, the screen 86 of FIG. 6 is more graphics and feature rich than the simple screen 84 of FIG. 5.

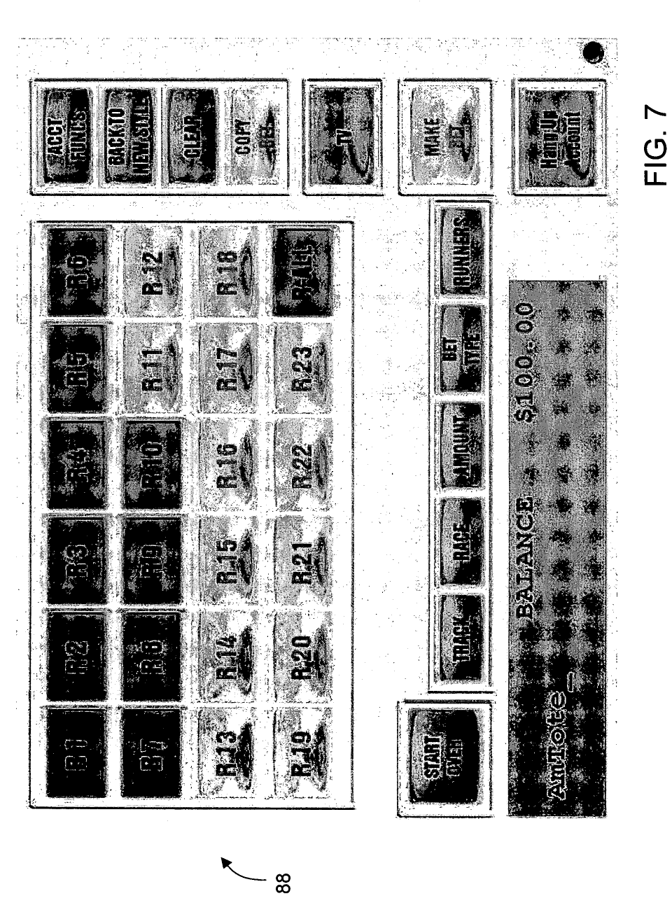

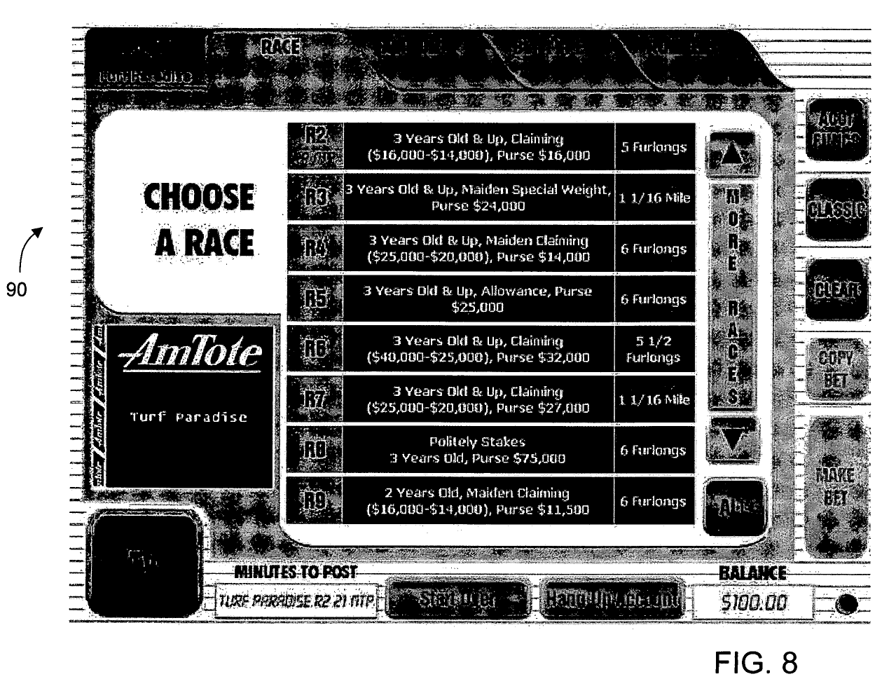

FIG. 7 illustrates a classic style screen 88 for use by experienced bettors in selecting races on which wagers are to be placed. The novice style screen 90 of Figure. 8 serves the same purpose, but is more graphics and feature rich for the less experienced user.

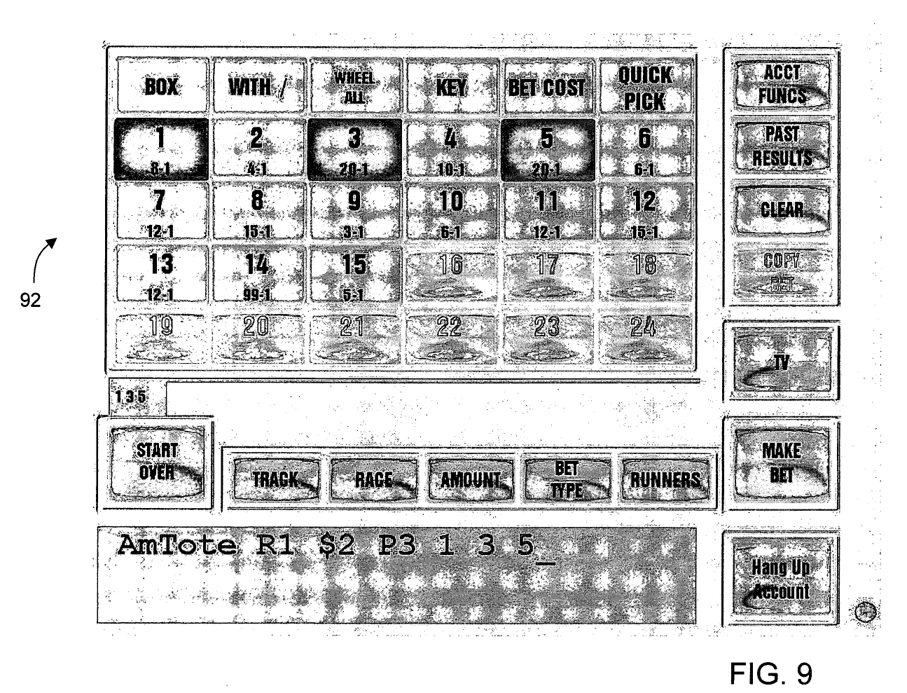

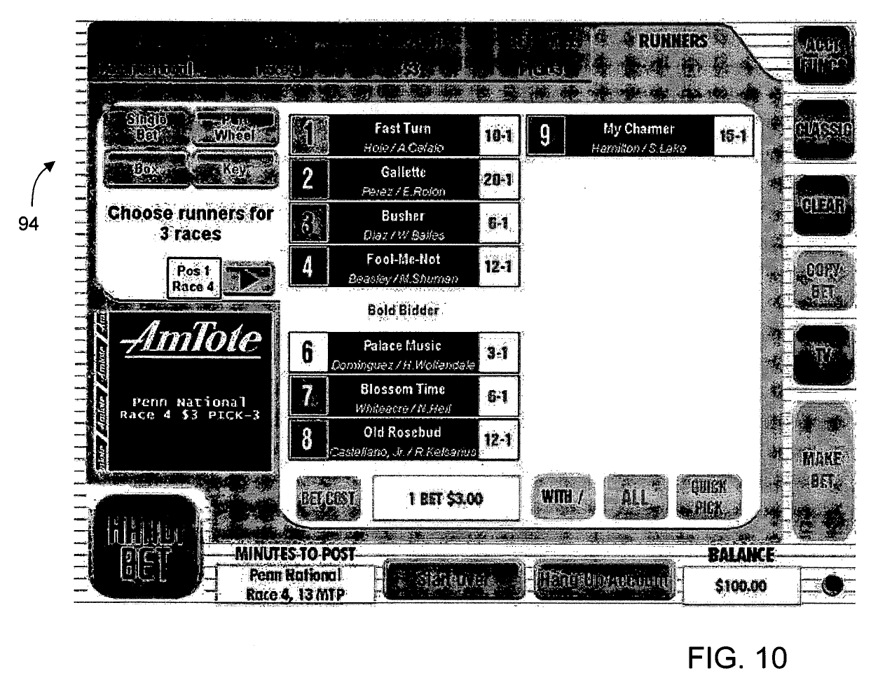

FIGS. 9 and 10 illustrate experienced and novice style screens for selecting runners during a wagering transaction. The screen 92 used by experienced users is simpler, but less user friendly, than the novice user screen 94 of FIG. 10.

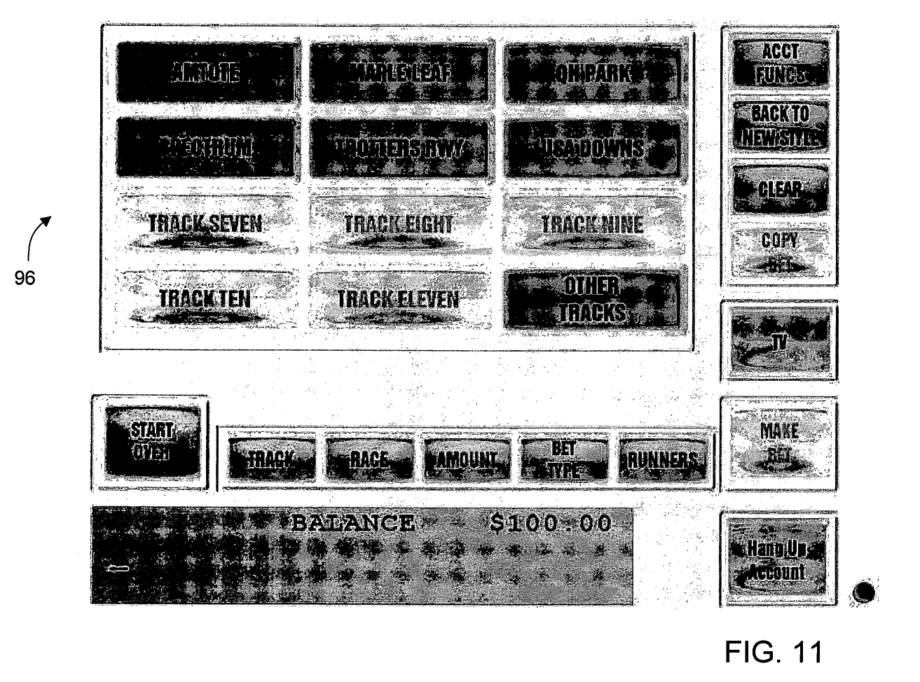

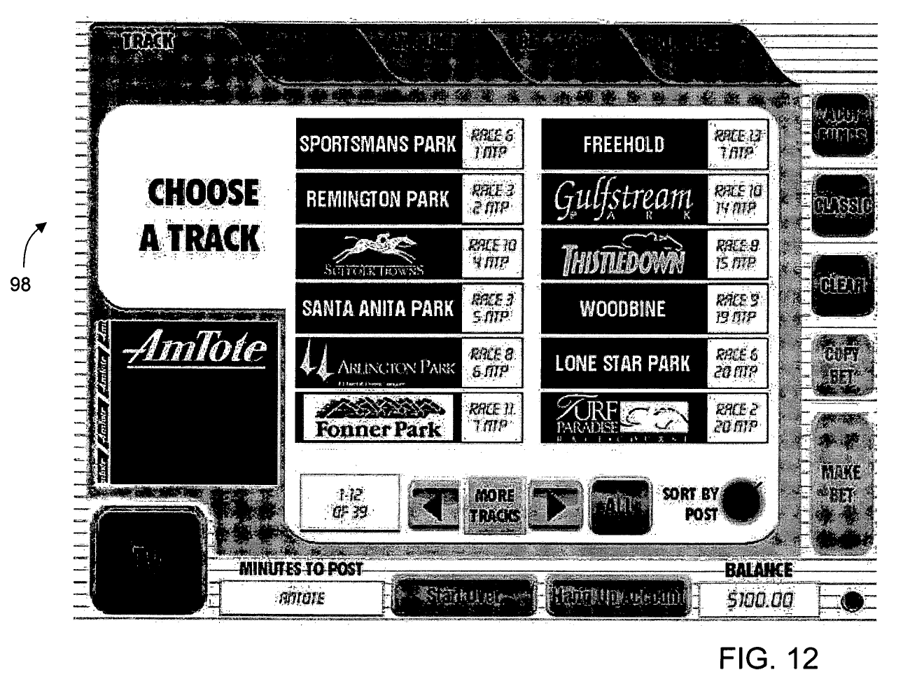

The screen 96 of FIG. 11 is used by experienced bettors to select racetracks at which wagers are to be placed. As can be seen, the corresponding novice user style, shown at screen 98 of FIG. 12, provides an enhanced graphical style with more user friendly features.

It should now be appreciated that the invention provides various embodiments for configuring and reconfiguring self-service wagering terminals at a racetrack or other wagering facility. Both system operator and customer initiated reconfigurations are possible. Based on the disclosure contained herein, the specific implementation of the invention will be straightforward to those skilled in the art, such as computer programmers and graphic designers who will generate the desired terminal screen styles, the software and firmware run by the central system and terminal processors, and the interfaces required to install them into the terminals. Various commercially available graphic programs are available for generating the screen designs. The program code to be run by the central system and terminals can be written in any of a variety of well known languages, such as C++ or the like.

Although the invention has been described in connection with various embodiments, it should be appreciated that numerous modifications and adaptations may be made thereto without departing from the scope of the invention as set forth in the claims.

What is claimed is:

1. A wagering terminal comprising:
a graphical user interface (GUI);
a processor for receiving input from said GUI and displaying information on a display associated with said GUI; and
memory for holding instructions to be processed by said processor for providing said display information and responding to input from said GUI;
said instructions being divided into a plurality of instruction sets, different ones of said sets being selectively executable by said processor to implement different wagering terminal styles to a user via said GUI.

2. A wagering terminal in accordance with claim 1, wherein said terminal styles include a veteran wagering patron style and a novice wagering patron style.

3. A wagering terminal in accordance with claim 1, wherein said terminal styles include a fast throughput style adapted for use when a wagering facility at which the terminal is used to place bets is more busy, and a slower throughput style adapted for use when said wagering facility is less busy.

4. A wagering terminal in accordance with claim 1, wherein particular instruction sets to be executed by said processor are selectable by a wagering facility operator.

5. A wagering terminal in accordance with claim 4, wherein said wagering facility operator selects a subset of said instruction sets to be available at said wagering terminal, and the terminal user selects one of said subset for execution by the processor to provide a desired wagering terminal style.

6. A wagering terminal in accordance with claim 1, wherein particular instruction sets to be executed by said processor are selectable by the wagering terminal user.

7. A wagering terminal in accordance with claim 1, wherein particular instruction sets to be executed by said processor are selected in response to a user identification element.

8. A method for reconfiguring wagering terminals at a wagering facility, said terminals having a graphical user interface (GUI), a processor for receiving input from said GUI and displaying information on a display associated with said GUI, and memory for holding instructions to be processed by said processor for providing said display information and responding to input from said GUI, comprising:
providing a plurality of instruction sets, different ones of said sets being executable by said processor to implement different wagering terminal styles to a user via said GUI, and
enabling at least-one of a wagering facility operator and a wagering facility patron to select from said plurality of instruction sets to provide a desired terminal style at the wagering terminal.

9. A method in accordance with claim 8, wherein said terminal styles include a veteran wagering patron style and a novice wagering patron style.

10. A method in accordance with claim 8, wherein:
said veteran wagering patron style enables users to quickly enter bets with minimal terminal interaction, and
said novice wagering patron style provides at least one of instructions and suggestions to users for placing bets.

11. A method in accordance with claim 8, wherein said terminal styles include a fast throughput style adapted for use when a wagering facility at which the terminal is used to place bets is more busy, and a slower throughput style adapted for use when said wagering facility is less busy.

12. A method in accordance with claim 8, wherein said wagering facility operator selects a subset of said instruction sets to be available at said wagering terminal, and the wagering facility patron selects one of said subset for execution by the processor to provide a desired wagering terminal style.

13. A method in accordance with claim 8, wherein at least one particular instruction set to be executed by said processor is automatically selected in response to a user identification element associated with a wagering patron.

14. A method in accordance with claim 13 wherein said wagering patron programs said user identification element with a particular style that the patron desires to use at the wagering terminal.

15. A method for configuring a plurality of self-service wagering terminals at a wagering facility,
said terminals each having a graphical user interface (GUI), a processor adapted to receive input from said GUI and display information on a display associated with said GUI, and memory for holding instructions to be processed by said processor for providing said display information and responding to input from said GUI,
said instructions being divided into a plurality of instruction sets, different ones of said sets being selectively executable by said processor to implement different wagering terminal styles to a user via said GUI;
configuring a first set of said terminals at said wagering facility with an instruction set implementing a first style to said first set of terminals; and
configuring a second set of said terminals at said wagering facility with an instruction set implementing a second style to said second set of terminals.

16. A method in accordance with claim 15 wherein said first and second styles are based on demographics of patrons using said wagering facility.

17. A method in accordance with claim 15, wherein said configuring steps are performed to create groups of terminals with different styles deployed at different locations in said wagering facility.
